(19) United States
(12) Patent Application Publication
(10) Pub. No.: US 2015/0052361 A1
(43) Pub. Date: Feb. 19, 2015

(54) METHOD FOR SETTING UP AN ENCRYPTED CONNECTION BETWEEN TWO COMMUNICATION APPLIANCES FOLLOWING PRIOR KEY INTERCHANGE VIA A SHORTHAUL CONNECTION

(71) Applicant: Appbyyou GmbH, Balgheim (DE)

(72) Inventor: Alexandra Winkler-Teufel, Balgheim (DE)

(73) Assignee: APPBYYOU GMBH, Balgheim (DE)

(21) Appl. No.: 14/367,384

(22) PCT Filed: Dec. 21, 2012
(86) PCT No.: PCT/DE2012/100398

§ 371 Date: Sep. 11, 2014

(30) Foreign Application Priority Data
Dec. 23, 2011 (EP) PCTEP2011006560
Dec. 5, 2012 (DE) 10 2012 111 834.5

(51) Int. Cl. H04L 29/06; H04W 12/06; H04W 12/10

(52) U.S. Cl. CPC H04L 63/0428; H04W 12/10; H04W 12/06; H04L 63/061
USPC 713/171

(57) ABSTRACT

In order to set up an encrypted communication link between two mobile appliances, it is proposed that the identification data and keys that are required therefor be interchanged in a one-off identification step and that, as part of the setup of the actual communication link, an unencrypted connection first of all be set up for reciprocal identification and then a connection encrypted with the initial interchanged keys be set up.

The present invention relates to a method for establishing an encrypted communication connection between two mobile devices.

The fundamental principle of any encryption is to process a message in such a manner that it remains unreadable for the recipient without suitable decryption means, in contrast to a clear text transmission. Encryption methods as such have already been known for a long time in this connection; the first encryption methods were already ascribed to Julius Caesar. He encrypted military messages in that a shift in the individual letters of the alphabet took place, which the recipient performed in the opposite direction to arrive at the clear text again. Since in this case, the question as to the number of letters by which a shift had taken place did not stand in the foreground, because by repeating the method, the clear text was obtained after the 25^{th} attempt, at the latest, the actual protection of the message consisted in keeping the method secret. It could function only due to the circumstance that undesired recipients did not know anything about encryption.

Nowadays, the situation is different, since information concerning various encryption methods is freely available everywhere, so that the simple Caesar method in the meantime belongs to the non-secure methods. Instead, the use of suitable keys with which encryption is carried out has moved into the foreground. The use of secret keys ensures that depending on the scope of this key, decryption becomes practically impossible. Due to this circumstance, the decryption problem for the interceptor shifts away from an understanding of encryption methods to the acquisition of information about the key itself.

Here, too, history knows a known example. The “Enigma” encryption system that the Germans used in World War II could only be decrypted by means of the capture of code books and an encryption apparatus, because separate, individual codes were indicated in the code books for every day. However, the use and distribution of such code books must be viewed as extremely complicated, on the one hand, and on the other hand, as history has shown, also as vulnerable.

Nowadays, in particular, because communication connections are formed essentially by way of the Internet, suitable encryption of confidential data confronts the user with quite a few challenges. Methods are known, for example what is called the Diffie-Hellman Key Exchange, in which the common key is determined by means of a calculation operation that is not reversible for an interceptor, and which are therefore considered secure possibilities for exchange of keys by way of non-secure channels, to a great extent. In the specific case mentioned, however, the possibility still exists of decrypting the messages using what is called a man-in-the-middle attack, in which the existence of direct communication is simulated, while in fact both communication partners communicate with a central node, which can therefore be tapped.

Particularly in the case of communication on the Internet, for example in peer-to-peer connections such as a Voice-over-IP connection, the risk exists that the server in that case can be misused as a node that can be tapped.

Against this background, the present invention is based on the task of creating a method for establishing an encrypted communication connection between two mobile devices, which opens up the possibility of guaranteeing the most secure encryption possible of a peer-to-peer connection, and, at the same time, using a method that can be handled as simply as possible for solving the problem of a key exchange.

This problem is solved by means of a method for establishing an encrypted communication connection between two mobile devices in accordance with the characteristics of claim 1. Further practical embodiments of such a method can be derived from the dependent claims.

According to the invention, it is provided for this purpose that first, a direct data exchange takes place, in a one-time identification step, between the two mobile devices that are communicating with one another, which can be carried out, for example, at a one-time meeting of the users of these mobile devices. Within the scope of the data exchange during this one-time identification step, a common key is exchanged, so that implementation of a symmetrical encryption method is made possible.

To establish an encrypted communication connection, a non-encrypted communication connection is then first established, with which the conversation participants can be identified. After identification of the mobile device communicating on the opposite side, in each instance, has taken place, and after it has been determined that a one-time identification step has taken place with this mobile device, a second communication connection is established, and the data part of the messages subsequently transmitted is encrypted with the common key exchanged during the one-time identification step.

Since the key code of only these two mobile devices is known on the basis of the one-time identification of the two mobile devices, it is possible to switch over to encrypted communication immediately, after reciprocal identification, while then, the non-encrypted communication connection that served for establishing communication can be terminated. In this way, it is also possible to allow secure communication in the case of peer-to-peer connections, because a transmission of the key code at the start of communication does not take place, neither directly nor indirectly.

To simplify the one-time identification step between the two mobile devices and to increase the security to be maintained in this regard, the one-time identification step can take place by means of a cable-connected transmission, by means of near field communication, or by means of a short-range wireless connection. In each case, it is necessary, in this connection, to exclude the possibility of third parties being able to follow the transmission. In particular, the near field communication can be structured in such a manner that a mobile device creates a key code, for example using a random method, codes this key code into a two-dimensional barcode and reproduces this barcode on its display, while subsequently, the second mobile device scans the display of the first mobile device using its optical sensor, detects the two-dimensional barcode in this way and also receives the key code by means of decryption of the two-dimensional barcode. At the same time, device-related information, such as unique hardware addresses, for example, and the like, can be exchanged during this identification process, so that the communication possibilities are linked not only with possession of the key code, but also to a specific mobile device. In particular, it can be provided that the two hardware addresses of the mobile devices be processed in a common key code.

In this regard, it is necessary to transmit not only the key code but also identification data such as an access code, for example, for reciprocal identification, so that when the first, non-encrypted communication connection is initiated, reciprocal identification is made possible.

In particular, a telephone connection by means of simply calling the second mobile device, a non-encrypted data connection by way of the Internet, if the Internet address is already known, or an Internet connection with the involvement of a switching server can be established as a non-encrypted communication connection. In the latter case, signing on to the server, in each instance, before the corresponding connection is established, might be necessary.

If the non-encrypted communication connection is a telephone connection, it is necessary to exchange the required Internet addresses of the mobile devices for the peer-to-peer connection to be established subsequently, so that addressing of the messages can also take place in practical manner. In the case of direct communication by means of the Internet or in the case of the involvement of the switching server, the address data are either directly known to the mobile devices or were passed on to the server when signing on, and are then made available by the server.

In a concrete embodiment, security can be increased in that one of the mobile devices, in each instance, as a central device, forms a central node of a star-shaped communication network, while the other mobile device is connected as a peripheral device. In this case, the central device can execute a program product as a native application, which product generates an Internet application after identification during the one-time identification step, and makes this application available on an Internet server for execution on the peripheral device. In this case, the access information and the hardware information of the second mobile device, which is used as a peripheral node in the star-shaped communication network because of the execution of the Internet application, has already flowed into this Internet application, so that the Internet application can be executed merely by the mobile device linked with it. In this regard, it is also provided to set up a separate, clearly identifiable Internet application for each mobile device to be added to the star-shaped communication network as a peripheral node. In such a star-shaped communication network, the central node can then in turn be used as a switching node between multiple peripheral nodes, in order to improve the possibilities of communication within the communication network. For the remainder, however, it is provided that multiple star-shaped communication networks be superimposed in such a manner that practically any participating mobile device functions as a central device in its own star-shaped communication network.

The invention described above will be explained in greater detail below, using an exemplary embodiment.

The drawing shows:

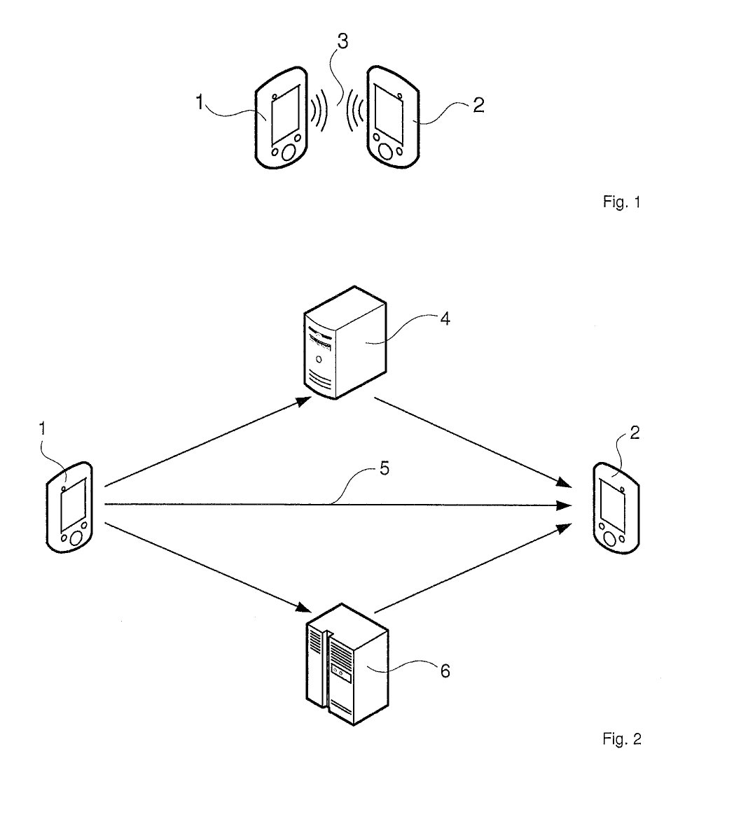

FIG. 1 two mobile devices during a one-time identification step, in a schematic representation,

FIG. 2 two mobile devices during a non-encrypted communication connection on three alternative paths, in a schematic representation,

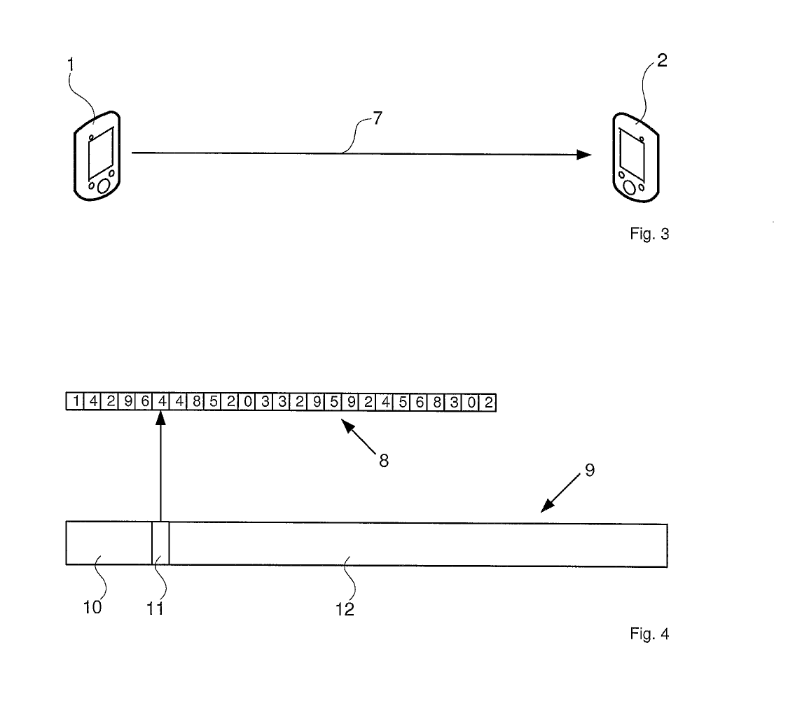

FIG. 3 two mobile devices during the finally encrypted communication connection, in a schematic representation, and

FIG. 4 a schematic representation of a coded, encrypted message.

FIG. 1 shows a first mobile device 1 as well as a second mobile device 2, which establish near field communication 3 in order to carry out a first, one-time identification step for establishing an encrypted communication connection. The goal of this method of procedure should ultimately be establishing subsequent encrypted direct connections between the two mobile devices 1 and 2, particularly by way of an Internet connection. For this purpose, it is necessary to keep a key code 8 on hand jointly on both mobile devices 1 and 2, with which encryption of the messages 9 to be transmitted from the first mobile device 1 to the second mobile device 2 or vice versa can be carried out. Within the scope of this first one-time identification step, access codes for reciprocal identification and a common key code for establishing symmetrical encryption are exchanged between the mobile devices 1 and 2, whereby the exchange can take place by way of a cable-connected direct connection. Alternatively, the possibility exists, within the scope of near field communication 3, that first, the hardware address of the one mobile device 1 or 2 is transmitted to the other mobile device 2 or 1, perhaps wirelessly, and finally, the actual key code is coded into a two-dimensional barcode, represented on the display, and scanned by the other mobile device 2, 1, in each instance, by its optical scanner, and decrypted.

FIG. 2 shows how the encrypted communication connection is established, whereby at the beginning of such an encrypted communication connection, first the conventional establishment of a non-encrypted communication connection takes place. Such a connection can be established between the first mobile device 1 and the second mobile device 2 either as a server connection 4, as a non-encrypted direct connection 5 or as a telephone connection 6. Further possibilities are also open for this. In the case of a server connection 4, both the first mobile device 1 and the second mobile device 2 will sign on to a server, whereupon the server passes the address data of the mobile devices 1 and 2 on to the other participant, in each instance, so that subsequently, the desired encrypted direct connection 7 can be established. In the case of a non-encrypted direct connection 5 by means of the Internet, the address situation is already clear, because such a direct connection 5 can be established only when the addresses are known. The third possibility that should be referred to here consists in establishing a telephone connection 6, for example in the form of a GSM connection UMTS connection, by way of which the Internet addresses of the mobile devices 1 and 2 are than also exchanged subsequently. Supplementally, access information is exchanged during this first handshake; this information permits reciprocal identification of the mobile devices 1 and 2.

FIG. 3 shows the two mobile devices 1 and 2 after the ultimately desired encrypted direct connection 7 has been established, which connection takes place after reciprocal identification using the access data previously exchanged and using the key code 8 initially exchanged. Such an encrypted direct connection 7 can be used as a data connection for the transmission of files, but it is also easily possible to use such an encrypted direct connection 7 for Voice-over-IP connections, for example.

FIG. 4 shows a possible example of coding of a message 9 used within the scope of the invention. Such a message 9 consists of a header 10, of a pointer 11, and of a data part with encrypted data 12, whereby the data have been modified by means of superimposition of the key code 8 that was exchanged during the one-time identification step. In this connection, the pointer 11 points to a position of the key code 8, in that the pointer 11 is a two-digit number, for example, which indicates the position of the key code 8. Starting with this position, a number of the key code 8 is successively superimposed onto the encrypted data 12, in every position, whereby when the end of the key code 8 is reached, one starts from the beginning again. On the basis of knowledge of the key code 8 on both sides and of transmission of the pointer 11, the message 9 can be decrypted again on the opposite side, and thereby the non-encrypted messages can be accessed.

What is described above is therefore a method for establishing an encrypted communication connection between two mobile devices, using a peer-to-peer direct connection on the Internet, wherein on the basis of a first, one-time identification between the participating mobile devices, secure and trustworthy transmission of a key code takes place, so that interception-proof transmission of messages can be carried out.

### REFERENCE SYMBOL LIST

1 first mobile device
2 second mobile device
3 near field communication
4 server connection
5 non-encrypted direct connection
6 telephone connection
7 encrypted direct connection
8 key code
9 message
10 header
11 pointer
12 encrypted data

1-10. (canceled)

11: Method for establishing an encrypted communication connection between two mobile devices (1, 2), in which method a data exchange between the two mobile devices (1, 2) takes place in a one-time identification step, and every time a communication connection is established, first a non-encrypted communication connection is established, and the mobile devices (1, 2), after reciprocal identification on the basis of the data exchanged in the one-time identification step, switch over to an encrypted communication connection for the exchange of encrypted data, the encryption of which data takes place using a key code (8) exchanged in the one-time identification step,
wherein within the scope of the one-time identification step, at least one access code for reciprocal identification of the mobile devices (1, 2) and a key code (8) for encryption of the data to be exchanged between the mobile devices (1, 2) are exchanged, in that the access code and the key code (8) are coded into a two-dimensional barcode and reproduced on a display of a first mobile device (1), and a second mobile device (2) scans the display of the first mobile device (1) with an optical sensor, detects the two-dimensional barcode, and decodes it.

12: Method according to claim 11, wherein a telephone connection (6), a non-encrypted direct connection (5) by means of the Internet or an Internet connection with the involvement of a switching server (4) is established as the non-encrypted communication connection.

13: Method according to claim 12, wherein the non-encrypted communication connection is a telephone connection (6), within the scope of which the addresses of the mobile devices (1, 2) required for establishing the encrypted communication connection are exchanged.

14: Method according to claim 11, wherein one of the mobile devices (1, 2), as a central device, forms a central node of a star-shaped communication network, while the other mobile device (2, 1), as a peripheral device, forms a peripheral node of this communication network, wherein the central device executes a program product as a native application, which product generates an Internet application for exclusive communication with the central node after the one-time identification step, with the inclusion of the data exchanged within the scope of the one-time identification step, and makes this application available on an Internet server for execution on the peripheral device.

15: Method according to claim 14, wherein the program product generates a separate, clearly identifiable Internet application for every peripheral node to be added.

16: Method according to claim 14, wherein the executability of each Internet application generated for a peripheral node is linked with a unique hardware address of the peripheral device.

17: Method according to claim 16, wherein the unique hardware address is exchanged between the central device and the peripheral device, within the scope of the one-time identification step.

18: Method according to claim 14, wherein the central node can be used as a switching node between multiple peripheral nodes.
